(19) United States
(12) Patent Application Publication
(10) Pub. No.: US 2007/0145880 A1
(43) Pub. Date: Jun. 28, 2007

(54) Low pressure mercury vapor discharge lamp

(75) Inventors: Cornelis Johannes Josephus Jansen, Eindhoven (NL); Wilhelmus Marie Hellebrekers, Eindhoven (NL); Bennie Josephus De Maagt, Eindhoven (NL); Rolf Erwin De Man, Eindhoven (NL); Peter Hubertus Franciscus Deurenberg, Eindhoven (NL); Theodorus Maria Hendriks, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/561,858

(22) PCT Filed: Jun. 15, 2004
(86) PCT No.: PCT/IB04/50905

§ 371 Date: Dec. 21, 2005

(30) Foreign Application Priority Data
Jun. 26, 2003 (EP) 03101913.6

(51) Int. Cl. H01J 1/62

(52) U.S. Cl. 313/490

(57) ABSTRACT

Low-pressure mercury vapor discharge lamp has a light-transmitting discharge vessel (10) enclosing, in a gastight manner, a discharge space (13) provided with a filling of mercury and a rare gas. The discharge vessel (10) comprises discharge means for maintaining a discharge in the discharge space (13). The discharge vessel is provided with a source of mercury (7). In addition, the discharge vessel is provided with a releasing means (8) for the controlled release of mercury vapor from the source of mercury. The releasing means is operative in response to a condition of the low-pressure mercury vapor discharge lamp, the condition being a characteristic of the discharge lamp and/or a predetermined time interval. The discharge lamp according to the invention operates under unsaturated mercury conditions. Preferably, the releasing means is operated via a switch device, preferably comprising a reed relay.

The invention relates to a low-pressure mercury vapor discharge lamp.

The invention also relates to a compact fluorescent lamp.

In mercury vapor discharge lamps, mercury constitutes the primary component for the (efficient) generation of ultraviolet (UV) light. A luminescent layer comprising a luminescent material may be present on an inner wall of the discharge vessel to convert UV to other wavelengths, for example, to UV-B and UV-A for tanning purposes (sun panel lamps) or to visible radiation for general illumination purposes. Such discharge lamps are therefore also referred to as fluorescent lamps. Alternatively, the ultraviolet light generated may be used for manufacturing germicidal lamps (UV-C). The discharge vessel of low-pressure mercury vapor discharge lamps is usually circular and comprises both elongate and compact embodiments. Generally, the tubular discharge vessel of compact fluorescent lamps comprises a collection of relatively short straight parts having a relatively small diameter, which straight parts are connected together by means of bridge parts or via bent parts. Compact fluorescent lamps are usually provided with an (integrated) lamp cap. Normally, the means for maintaining a discharge in the discharge space are electrodes arranged in the discharge space. In an alternative embodiment the low-pressure mercury vapor discharge lamp comprises a so-called electrodeless low-pressure mercury vapor discharge lamp.

In the description and claims of the current invention, the designation “nominal operation” is used to refer to operating conditions where the mercury-vapor pressure is such that the radiation output of the lamp is at least 80% of that when the light output is maximal, i.e. under operating conditions where the mercury-vapor pressure is optimal. In addition, in the description and claims, the “initial radiation output” is defined as the radiation output of the discharge lamp 1 second after switching on the discharge lamp, and the “run-up time” is defined as the time needed by the discharge lamp to reach a radiation output of 80% of that during optimum operation.

Low-pressure mercury-vapor discharge lamps are known comprising an amalgam. Such discharge lamps have a comparatively low mercury-vapor pressure at room temperature. As a result, amalgam-containing discharge lamps have the disadvantage that also the initial radiation output is comparatively low when a customary power supply is used to operate said lamp. In addition, the run-up time is comparatively long because the mercury-vapor pressure increases only slowly after switching on the lamp. Apart from amalgam-containing discharge lamps, low-pressure mercury-vapor discharge lamps are known which comprise both a (main) amalgam and a so-called auxiliary amalgam. If the auxiliary amalgam comprises sufficient mercury, then the lamp has a relatively short run-up time. Immediately after the lamp has been switched on, i.e. during preheating the electrodes, the auxiliary amalgam is heated by the electrode so that it relatively rapidly dispenses a substantial part of the mercury that it contains. In this respect, it is desirable that, prior to being switched on, the lamp has been idle for a sufficiently long time to allow the auxiliary amalgam to take up sufficient mercury. If the lamp has been idle for a comparatively short period of time, the reduction of the run-up time is only small. In addition, in that case the initial radiation output is (even) lower than that of a lamp comprising only a main amalgam, which can be attributed to the fact that a comparatively low mercury-vapor pressure is adjusted in the discharge space by the auxiliary amalgam. An additional problem encountered with comparatively long lamps is that it takes comparatively much time for the mercury liberated by the auxiliary amalgam to spread throughout the discharge vessel, so that after switching on such lamps, they demonstrate a comparatively bright zone near the auxiliary amalgam and a comparatively dark zone at a greater distance from the auxiliary amalgam, which zones disappear after a few minutes.

In addition, low-pressure mercury-vapor discharge lamps are known which are not provided with an amalgam and contain only free mercury. These lamps, also referred to as mercury discharge lamps, have the advantage that the mercury-vapor pressure at room temperature and hence the initial radiation output are relatively high as compared to amalgam-containing discharge lamps and as compared to discharge lamps comprising a (main) amalgam and an auxiliary amalgam. In addition, the run-up time is comparatively short. After having been switched on, comparatively long lamps of this type also demonstrate a substantially constant brightness over substantially the whole length, which can be attributed to the fact that the vapor pressure (at room temperature) is sufficiently high at the time of switching on these lamps.

In U.S. Pat. No. 5,274,305 the mercury vapor pressure in a low-pressure mercury discharge lamp is thermostatically controlled. The known low-pressure mercury discharge lamp includes electrodes and a source of mercury vapor sealed in a lamp envelope. A heater and a thermal switching device are in thermal contact with the source of mercury vapor. The heater is energized when the source of mercury vapor is below a predetermined temperature during operation of the lamp. Preferably, the heater is a resistance heater electrically connected in series with one of the lamp electrodes. The thermal switching device can be a bimetal thermostatic switch. The source of mercury vapor in the known low-pressure mercury vapor discharge lamp is typically an amalgam selected to have an optimum mercury vapor pressure at the maximum operating temperature of the lamp. The heater and the thermal switching device can be located external to the lamp envelope or can be located within the lamp envelope. The known low-pressure mercury vapor discharge lamp provides a relatively constant light output over a broad range of operating temperatures and different lamp orientations.

A relatively large amount of mercury is necessary for the known low-pressure mercury vapor discharge lamps in order to realize a sufficiently long lifetime. A drawback of the known discharge lamps is that they form a burden on the environment. This is in particular the case if the discharge lamps are injudiciously processed after the end of the lifetime.

The invention has for its object to eliminate the above disadvantage wholly or partly. According to the invention, a low-pressure mercury vapor discharge lamp of the kind mentioned in the opening paragraph for this purpose comprises:

a light-transmitting discharge vessel enclosing, in a gastight manner, a discharge space provided with a filling of mercury and a rare gas,

the discharge vessel comprising discharge means for maintaining a discharge in the discharge space,

the discharge vessel being provided with a source of mercury,

the discharge vessel being provided with a releasing means for the controlled release of mercury vapor from the source of mercury,

the releasing means being operative in response to a condition of the low-pressure mercury vapor discharge lamp,

the condition being a characteristic of the discharge lamp and/or a pre-determined time interval.

By providing a releasing means in the discharge vessel for the controlled release of mercury vapor from the source of mercury, the amount of mercury in the vapor phase in the discharge vessel during operation of the discharge lamp can be controlled during life of the discharge lamp. In addition, by making the releasing means responsive to a condition of the discharge lamp enables the discharge lamp to operate under unsaturated conditions during life of the discharge lamp. By measuring characteristics of the discharge lamp, the conditions for releasing mercury from the source of mercury can be set and the releasing means controls the amount of mercury vapor present in the discharge vessel during operation of the discharge lamp.

According to the invention, the condition which determines the release of mercury from the source of mercury is set by a characteristic of the discharge lamp and/or a pre-determined time interval. Operating the releasing means in response to a pre-determined time interval enables to gradually make available mercury during life of the discharge lamp. During life mercury is consumed in the discharge vessel, for instance in the glass and/or in the phosphor layer. This consumption of mercury resulting in less mercury being available for the maintenance of a discharge in the discharge vessel can be compensated by releasing some mercury into the discharge vessel during life of the discharge lamp at pre-determined times.

Operating the releasing means in response to a characteristic of the discharge lamp is a more sophisticated or “intelligent” means to enable the controlled release of mercury vapor from the source of mercury. The releasing means for the controlled release of mercury vapor can operate in response of the conditions in the discharge lamp.

Preferably the condition of the low-pressure mercury vapor discharge lamp is indicative of a content of mercury vapor in the discharge vessel below a pre-determined level. In a low-pressure mercury vapor discharge lamp operating under unsaturated condition, the mercury content is, preferably, higher than 0.02 mg Hg.

Preferably, the lamp characteristic is the arc characteristic of the discharge in the discharge vessel. Other lamp characteristics indicative of a reduced mercury content are a decreased lumen output of the discharge lamp, an increased infrared contribution to the lamp spectrum of the discharge lamp, a change in the lamp voltage, changes in the dynamic behavior of the discharge lamp and the occurrence of striations in the discharge lamp.

In the description and claims of the current invention, the designations “unsaturated” or “unsaturated mercury conditions” are used to refer to a low-pressure mercury vapor discharge lamp in which the amount of mercury dosed into the discharge vessel (during manufacturing) of the low-pressure mercury vapor discharge lamp is equal to or lower than the amount of mercury needed for a saturated mercury vapor pressure at nominal operation of the discharge lamp.

Operating a mercury vapor discharge lamp under unsaturated mercury conditions has a number of advantages. Generally speaking, the performance of unsaturated mercury discharge lamps (light output, efficacy, power consumption, etc.) is independent of the ambient temperature as long as the mercury pressure is unsaturated. This results in a constant light output which is independent on the way of burning the discharge lamp (base up versus base down, horizontally versus vertically). In practice, a higher light output of the unsaturated mercury vapor discharge lamp is obtained in the application. Unsaturated lamps combine a higher light output and an improved efficacy in applications at elevated temperatures with minimum mercury content. This results in ease of installation and in freedom of design for lighting and luminaire designers. An unsaturated mercury discharge lamp gives a relatively high system efficacy in combination with a relatively low Hg content. In addition, unsaturated lamps have an improved maintenance. Because the trends towards further miniaturization and towards more light output from one luminaire will continue the forthcoming years, it may be anticipated that problems with temperature in application will more frequently occur in the future. With an unsaturated mercury vapor discharge lamp these problems are largely reduced. Unsaturated lamps combine minimum mercury content with an improved lumen per Watt performance at elevated temperatures.

When the performance of unsaturated lamps is compared to so-called cold-spot or to so-called amalgam low-pressure mercury vapor discharge lamps the following advantages can be mentioned. In a “cold-spot” mercury discharge lamp, the mercury pressure is controlled by a so-called cold-spot temperature somewhere in the discharge vessel. In an amalgam mercury discharge lamp, the mercury pressure is controlled by means of an amalgam; in a number of such amalgam discharge lamps additionally an auxiliary amalgam is employed. The initial radiation output and the run-up time and ignition voltage of an unsaturated mercury discharge lamp are comparable to cold-spot lamps. Other properties like size (no cold-spot area necessary in an unsaturated discharge lamp; e.g. by introducing long stems), life time, color temperature, color rendering index and reliability are at the same level as known mercury discharge lamps. The maintenance of unsaturated lamps is expected to be better than that of the known compact fluorescent lamps (CFL) and fluorescent discharge lamps (TL). With unsaturated lamps miniaturization can be driven to its limits because thermal problems are minimized. For new installation unsaturated mercury discharge lamps this can result in a reduction of the total costs of ownership.

It is not an easy task to operate a low-pressure mercury vapor discharge lamp under unsaturated mercury conditions while simultaneously realizing a relatively long life of the discharge lamp. It is known that measures are taken in low-pressure mercury vapor discharge lamps to reduce the amount of mercury that during life of the discharge lamp is no longer able to contribute to the reactive atmosphere in the discharge space in the discharge vessel. Mercury is lost in that, due to the interaction of mercury and materials present in the lamp (such as glass, coatings, electrodes) and parts of the inner wall of the discharge vessel are blackened. Wall blackening does not only give rise to a lower light output but also gives the lamp an unaesthetic appearance, particularly because the blackening occurs irregularly, for example, in the form of dark stains or dots. Known measures to reduce the amount of mercury lost during life of the discharge lamp encompass special compositions of the glass of the discharge vessel, the application of protective coatings on the wall of the lamp vessel and electrode shields.

The measure according to the invention enables the manufacturing of long-life low-pressure mercury vapor discharge lamps which operate under conditions of unsaturated mercury content. Such unsaturated mercury discharge lamps have the advantage that the burden on the environment is reduced.

Several embodiments of the releasing means and sources of mercury can be realized. According to a preferred embodiment of the invention, a low-pressure mercury vapor discharge lamp of the kind mentioned in the opening paragraph is for this purpose characterized in that the releasing means is operated via a switch device. The switch device releases some mercury into the lamp vessel from the source of mercury. The switch device responds to a condition of the low-pressure mercury vapor discharge lamp indicative of a too low mercury vapor content in the discharge vessel.

Preferably, the switch device is mounted in the discharge vessel. In an alternative embodiment the switch device is mounted external to the discharge vessel.

According to a preferred embodiment of the invention, a low-pressure mercury vapor discharge lamp of the kind mentioned in the opening paragraph is for this purpose characterized in that the switch device comprises a reed relay. A reed relay is a well-known switch device in which current flowing in one circuit switches on and off a current in a second circuit. According to an alternative, preferred embodiment of the invention, a low-pressure mercury vapor discharge lamp of the kind mentioned in the opening paragraph is for this purpose characterized in that the releasing means is operated via an arc discharge. By way of example a controlled dc discharge, e.g. by means of a capacitor drained by the discharge, is created between the discharge electrode and the source of mercury.

Preferably, the source of mercury comprises at least one dispenser fiber comprising a mercury dispenser material. The releasing means may initiate a partial vaporization of the dispenser fibers while releasing mercury.

The mercury content in the discharge vessel can be expressed as the pressure of mercury in the discharge vessel of the low-pressure mercury vapor discharge lamp. According to a preferred embodiment of the invention, a low-pressure mercury vapor discharge lamp of the kind mentioned in the opening paragraph is for this purpose characterized in that the product of the mercury pressure p_{Hg} and the internal diameter Dᵢₙ of the discharge vessel is in the range 0.13≦p_{Hg}×Dᵢₙ≦8 Pa.cm. A discharge vessel of a low-pressure mercury vapor discharge lamp according to this preferred embodiment of the invention in which the product of the mercury pressure (expressed in Pa) and the internal diameter (expressed in mm) of the discharge vessel which is in the mentioned range from, contains a relatively low amount of mercury. The mercury content is considerably lower than what is normally provided for in known low-pressure mercury vapor discharge lamps. The low-pressure mercury vapor discharge lamp according to the second measure of the invention operates as a so-called “unsaturated” mercury vapor discharge lamp.

Preferably, the product of the mercury pressure pHs and the internal diameter Dᵢₙ of the discharge vessel is in the range 0.13≦p_{Hg}×Dᵢₙ≦4 Pa.cm. In this preferred regime of p_{Hg}×Dᵢₙ the mercury content in the discharge lamp is further reduced. In this preferred embodiment of the invention, the low-pressure mercury vapor discharge lamp according to the invention operates as an unsaturated mercury vapor discharge lamp.

A preferred embodiment of the low-pressure mercury vapor discharge lamp according to the invention is characterized in that the discharge vessel contains less than approximately 0.1 mg mercury. There is a tendency in governmental regulations to prescribe a maximum amount of mercury present in a low-pressure mercury vapor discharge lamp that if the discharge lamp comprises less than said prescribed amount allows the user to dispose of the lamp without environmental restrictions. If a mercury discharge lamp contains less than 0.2 mg of mercury such requirements are largely fulfilled. Preferably, the discharge vessel contains less than or equal to approximately 0.05 mg mercury.

These and other aspects of the invention are apparent from and will be elucidated with reference to the embodiments described hereinafter.

In the drawings:

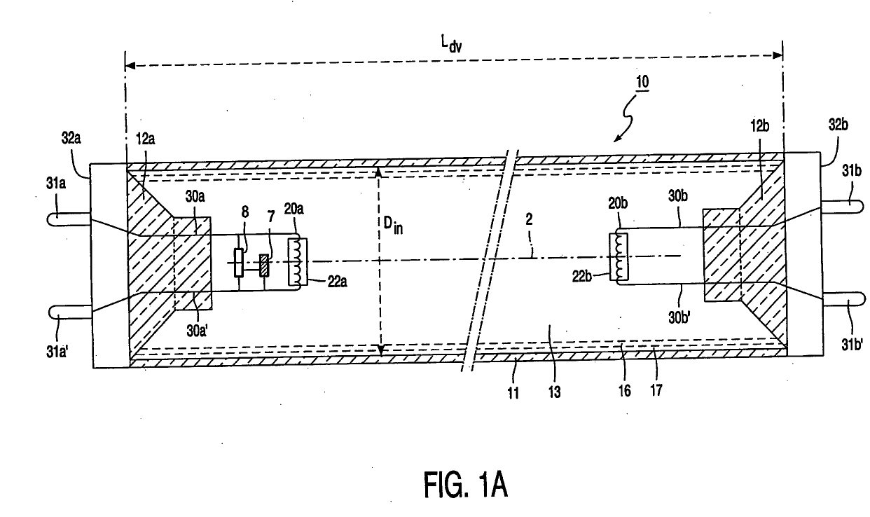

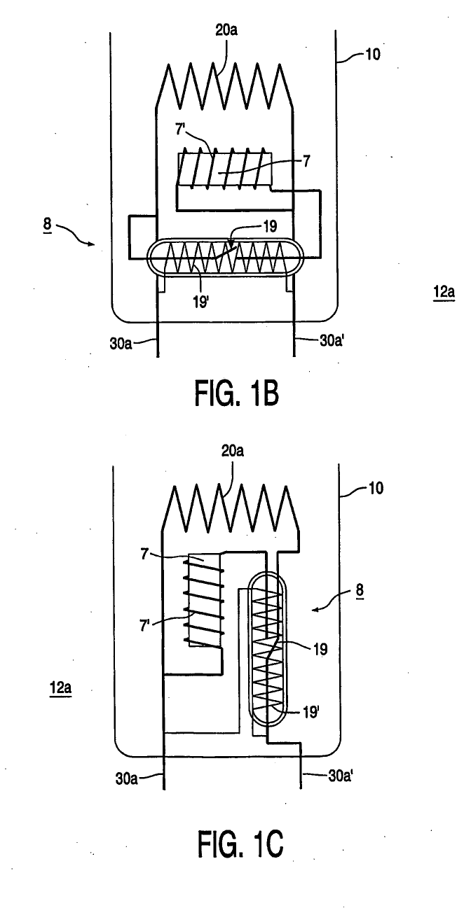

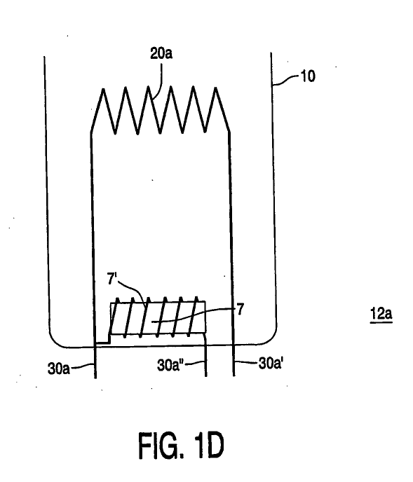

FIG. 1A is a cross-sectional view of an embodiment of the low-pressure mercury-vapor discharge lamp in accordance with the invention in longitudinal section;

FIG. 1B shows a first embodiment of the low-pressure mercury vapor discharge lamp according to the invention;

FIG. 1C shows a second embodiment of the low-pressure mercury vapor discharge lamp according to the invention;

FIG. 1D shows a third embodiment of the low-pressure mercury vapor discharge lamp according to the invention;

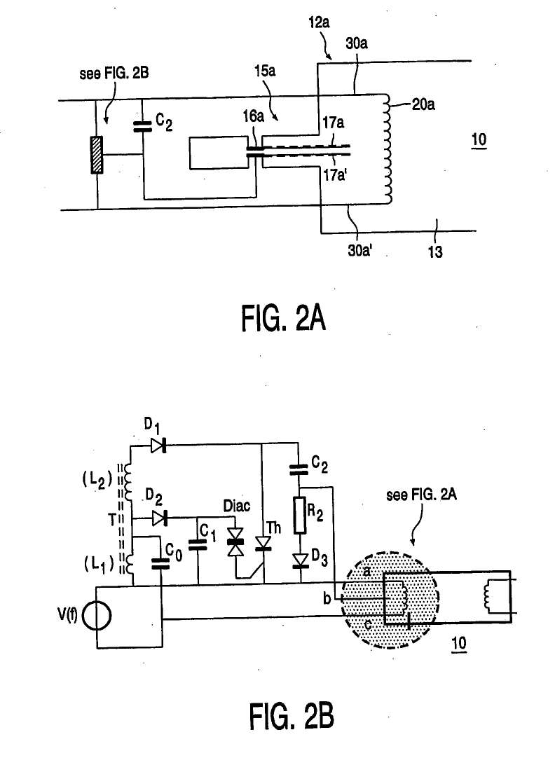

FIG. 2A is a cross-sectional view of a further alternative embodiment of a low-pressure mercury vapor discharge lamp according to the invention;

FIG. 2B shows a detail of FIG. 2A including a switching scheme, and

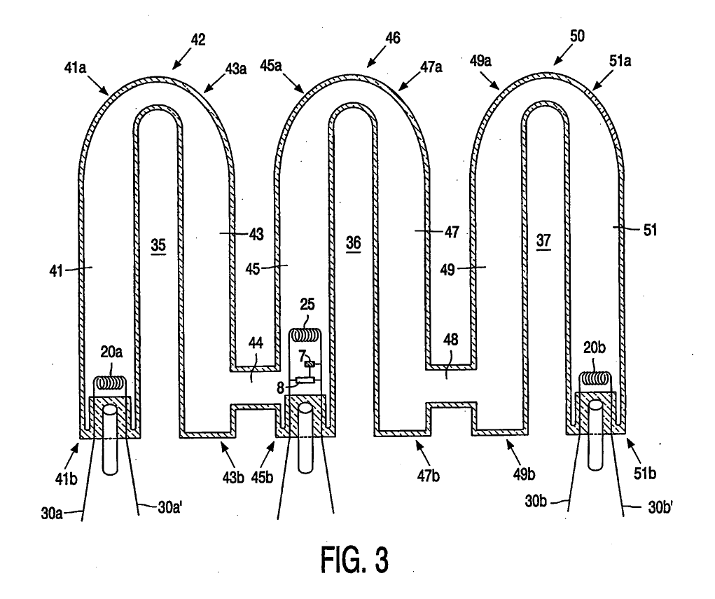

FIG. 3 is a cross-sectional view of a discharge vessel of a compact fluorescent lamp according to the invention

The Figures are purely diagrammatic and not drawn to scale. Notably, some dimensions are shown in a strongly exaggerated form for the sake of clarity. Similar components in the Figures are denoted as much as possible by the same reference numerals.

FIG. 1A very schematically shows a low-pressure mercury-vapor discharge lamp comprising a glass discharge vessel having a tubular portion 11 about a longitudinal axis 2, which discharge vessel transmits radiation generated in the discharge vessel 10 and is provided with a first and a second end portion 12a; 12b, respectively. In this example, the tubular portion 11 has a length L_{dv} of 120 cm and an inside diameter Dᵢₙ of 24 mm. The discharge vessel 10 encloses, in a gastight manner, a discharge space 13 containing a filling of mercury and an inert gas mixture comprising for example argon. In the example of FIG. 1A, the side of the tubular portion 11 facing the discharge space 13 is provided with a protective layer 17. In an alternative embodiment the first and second end portions 12a; 12b are also coated with a protective layer. In fluorescent discharge lamps, the side of the tubular portion 11 facing the discharge space 13 is, in addition, coated with a luminescent layer 16 including a luminescent material (for example a fluorescent powder) which converts the ultraviolet (UV) light generated by fallback of the excited mercury into (generally) visible light. In an alternative embodiment the luminescent layer 16 is, in addition, provided with a further protective layer (not shown in FIG. 1A).

In the example of FIG. 1A means for maintaining a discharge in the discharge space 13 are electrodes 20a; 20b arranged in the discharge space 13, said electrodes 20a; 20b being supported by the end portions 12a; 12b. The electrode 20a; 20b is a winding of tungsten covered with an electron-emitting substance, in this case a mixture of barium oxide, calcium oxide and strontium oxide. Current-supply conductors 30a, 30a′; 30b, 30b′ of the electrodes 20a; 20b, respectively, pass through the end portions 12a; 12b and issue from the discharge vessel 10 to the exterior. The current-supply conductors 30a, 30a′; 30b, 30b′ are connected to contact pins 31a, 31a′; 31b, 31b′ secured to a lamp cap 32a, 32b. In general, around each electrode 20a; 20b an electrode ring is arranged (not shown in FIG. 1A) on which a glass capsule for proportioning mercury is clamped.

In the example shown in FIG. 1A, the electrode 20a; 20b is surrounded by an electrode shield 22a; 22b which, preferably, is made from a ceramic material. Preferably, the electrode shield is made from a ceramic material comprising aluminum oxide. Particularly suitable electrode shields are manufactured from so-called densely sintered Al₂O₃, also referred to as DGA. Preferably, the temperature of the electrode shield 22a; 22b is 450° C. during nominal operation. In an alternative embodiment, the electrode shield 22a; 22b is made from stainless steel. At said high temperatures, such an electrode shield is dimensionally stable, corrosion resistant and exhibits a relatively low heat emissivity.

FIG. 1A very schematically shows that the discharge vessel 10 is provided with a source of mercury 7. In the example of FIG. 1A, the source of mercury 7 is attached to one of the current-supply conductors 30a′. In addition, the discharge vessel 10 is provided with a releasing means 8 for the controlled release of mercury vapor from the source of mercury 7 (FIG. 1A shows schematically a connection between the source of mercury and the releasing means; see FIGS. 1B and 1C for more detail). The releasing means 8 is operative in response to a condition of the low-pressure mercury vapor discharge lamp, the condition being a characteristic of the discharge lamp and/or a pre-determined time interval.

FIG. 1B very schematically shows a first embodiment of the low-pressure mercury vapor discharge lamp according to the invention. The end portion 12a supports the electrode 20a via the current supply conductors 30a, 30a′. In the embodiment shown in FIG. 1B the discharge vessel 10 is provided with a source of mercury 7. In addition, the source of mercury 7 is supported by one of the current-supply conductors 30a′. The source of mercury 7 can for instance be a rod of Ti₃Hg from which Hg can be released irreversible. In addition, the discharge vessel 10 is provided with a releasing means 8 for the controlled release of mercury vapor from the source of mercury 7. In the embodiment of FIG. 1B the releasing means 8 comprises an encapsulated reed relay 19 activated by a dc component added to the normal lamp current. When the reed relay 19 when a current is fed through line 19′, the source of mercury 7 is heated via the heating wire 7′ surrounding the source of mercury 7 and releases mercury which becomes available to the discharge in the discharge space 13. The releasing means 8 is operative in response to a condition of the low-pressure mercury vapor discharge lamp, the condition being a characteristic of the discharge lamp and/or a pre-determined time interval. By way of example the characteristic of the discharge lamp can be the arc characteristic in the discharge space 13 which can be determined by measuring the voltage over and the current through the discharge lamp. The lamp current in relation to the lamp voltage are indicative of the arc characteristic of the discharge lamp.

Other lamp characteristics indicative of a reduced mercury content in the discharge vessel are a decreased lumen output of the discharge lamp (which can be measured via a output sensor), an increased infrared contribution to the lamp spectrum of the discharge lamp, a change in the lamp voltage, changes in the dynamic behavior of the discharge lamp and the occurrence of striations in the discharge lamp.

FIG. 1C very schematically shows a second embodiment of the low-pressure mercury vapor discharge lamp according to the invention. The source of mercury 7 is supported by one of the current-supply conductors 30a. The releasing means 8 controls the release of mercury vapor from the source of mercury 7. In the embodiment of FIG. 1C the releasing means 8 comprises an encapsulated reed relay 19 activated by a dc component added to the normal lamp current. When the reed relay 19 when a current is fed through line 19′, the source of mercury 7 is heated via the heating wire 7′ surrounding the source of mercury 7 and releases mercury which becomes available to the discharge in the discharge space 13.

FIG. 1D very schematically shows a third embodiment of the low-pressure mercury vapor discharge lamp according to the invention. The source of mercury 7 is supported by one of the current-supply conductors 30a. An additional current-supply conductor 30a″ is provided in the end portion 12a of the discharge vessel 10. This additional current-supply conductor 30a″ provides an electrical connection to a releasing means outside the discharge vessel (not shown in FIG. 1D; see by way of example the embodiments shown in FIGS. 2A and 2B) The releasing means controls the release of mercury vapor from the source of mercury 7 (e.g. by energizing the heating wire 7′).

FIG. 2A very schematically shows a cross-sectional view of an further alternative embodiment of a low-pressure mercury vapor discharge lamp according to the invention. In the example of FIG. 2A the discharge vessel 10 comprises electrodes 20a (only one electrode is shown in FIG. 2A) arranged in the discharge space 13, said electrode 20a being supported by the end portion 12a. Current-supply conductors 30a, 30a′ of the electrodes 20a pass through the end portions 12a and issue from the discharge vessel 10 to the exterior.

In the embodiment shown in FIG. 2A an additional ferrule 16a is placed in the exhaust tube 15a. Connected to the ferrule 16a are some (isolated) dispenser fibers 17a, 17a′ of a mercury dispenser material. When the mercury vapor content in the discharge vessel 10 becomes below a predetermined level, a controlled (dc) discharge is created between the electrode 20a carried by the current-supply conductor 30a; 30a′ and (one of) these dispenser fibers 17a; 17a′. In the example of FIG. 2A, the ferrule 16a serves as cathode whereas the electrode 20a serves as anode. One way to create a controlled discharge is by means of a dc charged parallel capacitor C2, which is drained by the dc discharge. Eventually the hot cathode spot of the dc discharge will heat up only one of the dispenser fibers 17a and upon vaporizing this dispenser fiber 17a mercury is released. The dispenser fiber 17a will be partially evaporated because of lack of energy in the parallel capacitor C2 or will evaporate completely when there is enough energy in the capacitor C2. In the latter case, the cathode hot spot will eventually touch the ferrule 16a and the hot spot remains there until there is not enough energy left in the capacitor C2. The next time, another dispenser fiber 17a′ takes its turn until no dispenser fibers are available.

In an alternative embodiment of the melting process one of the vaporized metals serves as a (hydrogen/oxygen) getter.

FIG. 2B very schematically shows a detail of FIG. 2A including a switching scheme. In the embodiment of the invention shown in FIG. 2B, a primary winding L1 of a (small) hf transformer T together with a series capacitor C0 form a series resonance circuit. When the electrode heating frequency equals the resonance frequency, the capacitor C1 will be charged until the breakdown voltage of a Diac (20-40V) is reached. During that time the high voltage capacitor C2 is charged by means of a secondary winding L2 of the transformer T. As a next step, the thyristor Th is fired and by means of the charged high voltage capacitor C2, the ferrule 16a is put on a high negative potential with respect to the electrode 20a. If this voltage is high enough (typically above approximately 400V), a single (vapor arc like) discharge will occur between one of the dispenser fibers 17a; 17a′ and the electrode 20a. Depending on the energy in the capacitor C2, one of the dispenser fibers 17a; 17a′ wire will be partially or totally evaporated. After that it takes a while to recharge the high voltage capacitor C2 if the operating frequency of the main discharge electrode heating has not been changed. Subsequently, the arcing and melting/evaporating process will start all over again until all dispenser fibers 17a; 17a′ are evaporated. To prevent this, the operating frequency is tuned out of resonance on time. Hence, by changing the operating frequency of the heating of the electrode 20a (e.g. by an “intelligent” hf ballast) (additional) mercury can be dosed at predetermined time intervals and/or in a controlled way during life of the low-pressure mercury vapor discharge lamp. In FIG. 2B a number of diodes D1, D2, D3 and a resistance R2 have been provided. An alternative for a Diac is a Sidac.

In order to create the desired discharge an additional feed-through is created in the end portion 12a of the discharge vessel. An advantage of the switching scheme creating a vapor arc like discharge as shown in FIG. 2B is that the switching scheme can be build into the lamp cap. In this manner, the low-pressure mercury vapor discharge lamp according to the invention comprises two contact pins 31a, 31a′; 31b, 31b′ secured to lamp caps 32a, 32b at either side of the discharge vessel 10.

FIG. 3 schematically shows a cross-sectional view of a discharge vessel of a compact fluorescent lamp according to the invention. The compact fluorescent lamp comprises at least two dual-shaped lamp parts 35; 36; 37. Each dual-shaped lamp parts 35; 36; 37 comprises a first tube 41; 45; 49 and a second tube 43; 47; 51. In the example of FIG. 3 the compact fluorescent lamp comprises three dual-shaped lamp parts referenced 35; 36, 37. The first tube 41; 45; 49 and the second tube 43; 47; 51 at a first end portion 41a, 43a; 45a, 47a; 49a, 51a of each tube 41, 43; 45, 47; 49, 51 are interconnected via a tube interconnection means 42; 46; 50. In the example of FIG. 3, the tube interconnection means 42; 46; 50 comprise so-called bent portions. In an alternative embodiment the tube interconnection means comprise so-called bridge portions.

In the compact fluorescent lamp as shown in FIG. 3 a discharge path is formed through the tubes 41, 43; 45, 47; 49, 51 between a first electrode 20a and a second electrode 20b.

The first electrode 20a is provided at a second end portion referenced 41b of the tube referenced 41. The second electrode 20b is provided at a second end portion referenced 51b of the tube referenced 51. The second end portions 41b; 51b face away from the first end portions 41a; 51a. To obtain a relatively long electrode path, the electrodes 20a; 20b are arranged at extreme ends of the fluorescent lamp.

In the example of FIG. 3 the first and second electrodes 20a; 20b are supported by the respective second end portions 41b; 51b. Current-supply conductors 30a, 30a′; 30b, 30b′ of the electrodes 20a; 20b respectively, pass through the second end portions 41b; 51b and issue from the discharge lamp to the exterior.

The side of the tubes 41, 43; 45, 47; 49, 51 facing the discharge space is preferably provided with a protective layer (not shown in FIG. 3). The side of the tubes 41, 43; 45, 47; 49, 51 facing the discharge space is, in addition, coated with a luminescent layer (not shown in FIG. 3) which includes a luminescent material (for example a fluorescent powder) which converts the ultraviolet (UV) light generated by fallback of the excited mercury into (generally) visible light.

Apart from the second end portions 41b; 51b provided with an electrode 20a; 20b, further second end portions 43b; 45b; 47b; 49b of the respective tubes 43; 45; 47; 49 are provided with a sealed end. Bridge parts 44; 48 for mutually connecting tubes 43, 45; 47, 49 of adjacent dual-shaped lamp parts 35, 36; 36, 37 are provided in the proximity of the second end portions 43b, 45b; 47b, 49b of the tubes 43, 45; 47, 49. At least one of the further second end portions 45b is provided with the source of mercury 7 and the releasing means 8.

In the example of FIG. 3, a heating means 25 is provided at the further second end portion 45b. The heating means 45b provides an external influence of the temperature of the releasing means 8. Preferably, the heating means 25 is a winding of tungsten and is not covered with an electron-emitting substance. The heating means 25 may be covered by a protective coating. By providing the heating means 25 in the vicinity of the releasing means 8, the compact fluorescent lamp can be operated under so-called unsaturated conditions. When the mercury content is lower than a certain pre-determined level, the heating means 25 is heated the temperature of the releasing means 8 is influenced, whereby the release of mercury from the source of mercury 7 is regulated. Preferably, the housing 70 contains regulating means for regulating the current through the heating means 25. The regulating means may be implemented in software and/or in hardware. By employing one of the “unused” second end portions of the compact fluorescent lamp, a compact embodiment of the low-pressure mercury vapor discharge lamp according to the invention is realized.

Operating a mercury vapor discharge lamp under unsaturated mercury conditions has a number of advantages. Generally speaking, the performance of unsaturated mercury discharge lamps (light output, efficacy, power consumption, etc.) is independent of the ambient temperature as long as the mercury pressure is unsaturated. This results in a constant light output which is independent on the way of burning the discharge lamp (base up versus base down, horizontally versus vertically). In practice, a higher light output of the unsaturated mercury vapor discharge lamp is obtained in the application. Unsaturated lamps combine a higher light output and an improved efficacy in applications at elevated temperatures with minimum mercury content. This results in ease of installation and in freedom of design for lighting and luminaire designers. An unsaturated mercury discharge lamp gives a relatively high system efficacy in combination with a relatively low Hg content. In addition, unsaturated lamps have an improved maintenance. Because the trends towards further miniaturization and towards more light output from one luminaire will continue the forthcoming years, it may be anticipated that problems with temperature in application will more frequently occur in the future. With an unsaturated mercury vapor discharge lamp these problems are largely reduced. Unsaturated lamps combine minimum mercury content with an improved lumen per Watt performance at elevated temperatures.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A low-pressure mercury vapor discharge lamp comprising:
a light-transmitting discharge vessel (10) enclosing, in a gastight manner, a discharge space (13) provided with a filling of mercury and a rare gas,
the discharge vessel (10) comprising discharge means for maintaining a discharge in the discharge space (13),
the discharge vessel (10) being provided with a source of mercury (7),
the discharge vessel (10) being provided with a releasing means (8) for the controlled release of mercury vapor from the source of mercury (7),
the releasing means (8) being operative in response to a condition of the low-pressure mercury vapor discharge lamp,
the condition being a characteristic of the discharge lamp and/or a pre-determined time interval.

2. A low-pressure mercury vapor discharge lamp as claimed in claim 1, characterized in that the releasing means (8) is operated via a switch device (9).

3. A low-pressure mercury vapor discharge lamp as claimed in claim 2, characterized in that the switch device (9) is mounted in the discharge vessel (10).

4. A low-pressure mercury vapor discharge lamp as claimed in claim 2, characterized in that the switch device (9) comprises a reed relay (19).

5. A low-pressure mercury vapor discharge lamp as claimed in claim 1, characterized in that the releasing means (8) is operated via an arc discharge.

6. A low-pressure mercury vapor discharge lamp as claimed in claim 1, characterized in that the source of mercury (7) comprises at least one dispenser fiber (17a; 17a′) comprising a mercury dispenser material.

7. A low-pressure mercury vapor discharge lamp as claimed in claim 1, characterized in that the condition of the low-pressure mercury vapor discharge lamp is indicative of a content of mercury vapor in the discharge vessel (10) below a pre-determined level.

8. A low-pressure mercury vapor discharge lamp as claimed in claim 1, characterized in that the lamp characteristics is the arc characteristic of the discharge in the discharge vessel (10), a decreased lumen output of the discharge lamp, an increased infrared contribution to the lamp spectrum of the discharge lamp, a change in the lamp voltage, changes in the dynamic behavior of the discharge lamp and/or the occurrence of striations in the discharge lamp.

9. A low-pressure mercury vapor discharge lamp as claimed in claim 1, characterized in that the product of the mercury pressure pHg and the internal diameter Din of the discharge vessel (10) is in the range 0.13≦pHg×Din≦8 Pa.cm.

10. A low-pressure mercury vapor discharge lamp as claimed in claim 9, characterized in that the product of the mercury pressure pHg and the internal diameter Din of the discharge vessel (10) is in the range 0.13≦pHg×Din≦4 Pa.cm.

11. A low-pressure mercury vapor discharge lamp as claimed in claim 1, characterized in that the discharge vessel (10) contains less than 0.1 mg mercury.

12. A compact fluorescent lamp comprising a low-pressure mercury-vapor discharge lamp as claimed in claim 1, the compact fluorescent lamp comprising:
at least two dual-shaped lamp parts (35; 36; 37), each comprising a first tube (41; 45; 49) and a second tube (43; 47; 51),
the first tube (41; 45; 49) and the second tube (43; 47; 51) at a first end portion (41a, 43a; 45a, 47a; 49a, 51a) of each tube (41, 43; 45, 47; 49, 51) being interconnected via a tube interconnection means (42; 46; 50),
a discharge path being formed through the tubes (41, 43; 45, 47; 49, 51) between a first (20a) and a second electrode (20b), each electrode (20a, 20b) being provided at a second end portion (41b; 51b) of one of the tubes (41; 51), the second end portions (41b; 51b) facing away from the first end portions (41a; 51a), the electrodes (20a; 20b) being provided at extreme ends of the fluorescent lamp,
further second end portions (43b; 45b; 47b; 49b) of the tubes (43; 45; 47; 49) being provided with a sealed end,
bridge parts (34; 38) for mutually connecting tubes (43, 45; 47, 49) of adjacent dual-shaped lamp parts (35, 36; 36, 37) being provided in the proximity of the second end portions (43b, 45b; 47b, 49b) of the tubes (43, 45; 47, 49),
at least one of the further second end portions (45b) being provided with the source of mercury (7) and the releasing means (8).

13. A compact fluorescent lamp as claimed in claim 12, characterized in that a heating means (25) is provided at the further second end portion (45b).

14. A compact fluorescent lamp as claimed in claim 12, characterized in that the tube interconnection means (42; 46; 50) is either a bridge portion or a bent portion.

15. A compact fluorescent lamp as claimed in claim 12, characterized in that a lamp housing is attached to the discharge vessel of the low-pressure mercury-vapor discharge lamp, which lamp housing is provided with a lamp cap.
